(19) United States
(12) Patent Application Publication
(10) Pub. No.: US 2009/0260765 A1
(43) Pub. Date: Oct. 22, 2009

(54) Method and Apparatus for Retaining a Wheel

(75) Inventors: Lawrence J. Lawson, Troy, MI (US); John Fox, Fraser, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Android Industries LLC, Auburn Hills, MI (US)

(21) Appl. No.: 12/104,579

(22) Filed: Apr. 17, 2008

(51) Int. Cl. B60C 25/05

(52) U.S. Cl. 157/18; 157/19; 157/20; 157/21; 157/1

(57) ABSTRACT

A device for retaining a wheel having an inner diameter during an assembly operation of a tire-wheel assembly at a single-cell workstation includes a claw portion that releasably-attaches to the inner diameter of the wheel, including a fixed portion and a rotatable portion, wherein the rotatable portion is rotatably-disposed upon the fixed portion; wheel-engaging portions slidably-disposed upon the rotatable portion; sliding portions that are slidably-disposed within the fixed portion, wherein each sliding portion is coupled with one of each wheel-engaging portion, and an actuator portion coupled to the rotatable portion. A method is also disclosed.

### FIELD OF THE INVENTION

The disclosure relates to tire-wheel assemblies and to a method and apparatus for retaining a wheel during the assembly operation of a tire-wheel assembly.

### DESCRIPTION OF THE RELATED ART

It is known in the art that a tire-wheel assembly is assembled in several steps. Usually, conventional methodologies that conduct such steps require a significant capital investment and human oversight. The present invention overcomes drawbacks associated with the prior art by setting forth a simple device utilized for retaining a wheel during an assembly operation of a tire-wheel assembly.

### BRIEF DESCRIPTION OF THE DRAWINGS

The disclosure will now be described, by way of example, with reference to the accompanying drawings, in which:

FIG. 1 illustrates a partial environmental view of a workstation for assembling a tire-wheel assembly in accordance with an exemplary embodiment of the invention;

FIG. 2A illustrates an exploded perspective view of a claw portion of the workstation of FIG. 1 in accordance with an exemplary embodiment of the invention;

FIG. 2B illustrates an assembled perspective view of the claw portion of FIG. 2A in accordance with an exemplary embodiment of the invention;

FIGS. 3A-3C illustrate top views of the claw portion of FIG. 2B in accordance with an exemplary embodiment of the invention;

FIGS. 4A-4C illustrate cross-sectional views of the claw portion of FIGS. 3A-3C in accordance with an exemplary embodiment of the invention;

FIG. 5 illustrates a partial environmental view of a workstation for assembling a tire-wheel assembly in accordance with an exemplary embodiment of the invention;

FIG. 6A illustrates an exploded perspective view of a claw portion of the workstation of FIG. 5 in accordance with an exemplary embodiment of the invention;

FIG. 6B illustrates an assembled perspective view of the claw portion of FIG. 6A in accordance with an exemplary embodiment of the invention;

FIGS. 7A-7G illustrate cross-sectional views of a method for inflating a tire-wheel assembly utilizing the claw portion of FIGS. 6A-6B;

FIG. 8A is a portion of the cross-sectional view of FIG. 7C according to line 8A;

FIGS. 8B-8E illustrate manipulated portions of the cross-sectional view according to FIG. 8A; and

FIG. 8F is a portion of the cross-sectional view of FIG. 7D according to line 8F.

### DETAILED DESCRIPTION OF THE INVENTION

The Figures illustrate an exemplary embodiment of a device utilized for retaining a wheel during an assembly operation of a tire-wheel assembly in accordance with an embodiment of the invention. Based on the foregoing, it is to be generally understood that the nomenclature used herein is simply for convenience and the terms used to describe the invention should be given the broadest meaning by one of ordinary skill in the art.

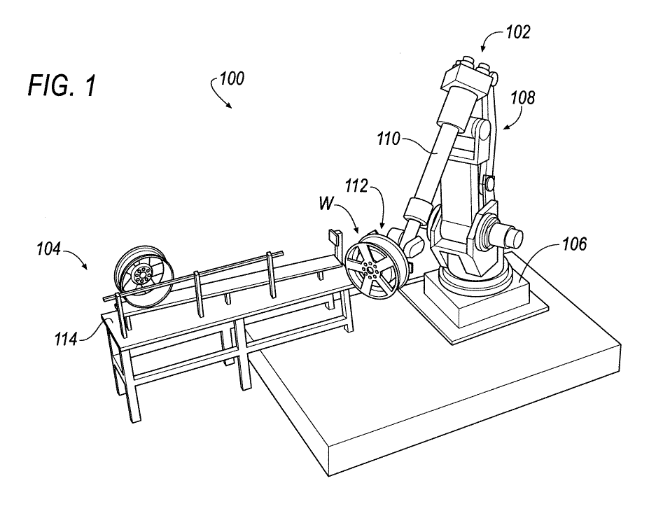

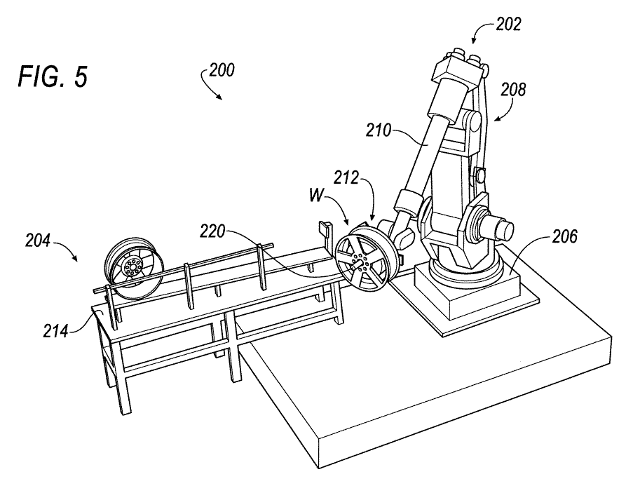

In an embodiment, the systems shown at FIGS. 1 and 5 may be referred to as “single-cell” workstations 100, 200. In the forgoing disclosure, it will be appreciated that term “single-cell” indicates that the workstation 100, 200 provides a tire-wheel assembly without requiring a plurality of successive, discrete workstations that may otherwise be arranged in a conventional assembly line such that a partially-assembled tire-wheel assembly is “handed-off” along the assembly line (i.e., “handed-off” meaning that an assembly line requires a partially-assembled tire-wheel assembly to be retained by a first workstation of an assembly line, worked on, and released to a subsequent workstation in the assembly line for further processing).

Rather, the single cell workstation 100, 200 provides one workstation having a plurality of subs-stations, each performing a specific task in the process of assembling a tire-wheel assembly. As such, the novel single-cell workstation 100, 200 significantly reduces the cost and investment associated with owning/renting the real estate footprint associated with a conventional tire-wheel assembly line while also having to provide maintenance for each individual workstation defining the assembly line. Thus, capital investment and human oversight is significantly reduced when a single cell workstation 100, 200 is employed in the manufacture of tire-wheel assemblies.

Referring to FIG. 1, a system for assembling a tire-wheel assembly, is shown generally at 100 according to an embodiment. The system 100 includes a device 102. In operation, the device 102 receives and retains a wheel, W, which eventually comprises part of a tire-wheel assembly. The ability of the device 102 to retain the wheel, W, throughout the assembling process eliminates the need to “hand-off” a partially assembled tire-wheel assembly to a subsequent workstation of a plurality of workstations in an assembly line.

As seen in FIG. 1, the device 102 in the single-cell workstation 100 may include a robotic arm 102 that may be located in a substantially central position relative a plurality of sub-stations. In the present disclosure, one sub-station of the plurality of sub-stations is shown generally at 104. The workstation 104 is referred to as a wheel repository sub-station.

In FIG. 1, a wheel, W, is attached to the robotic arm 102, which is shown in an at-rest, idle position. The robotic arm 102 may include, for example, a base portion 106, a body portion 108 connected to the base portion 106, an arm portion 110 connected to the body portion 108 and a claw portion 112 connected to the arm portion 110.

The body portion 108 is rotatably-connected to the base portion 106 such that the body portion 108 may be pivoted 360° relative the base portion 106. Further, the body portion 108 may be generally hinged to the base portion 106 having, for example, hinged, scissor-style arms such that the body portion 108 may be articulated vertically upward or downward relative the base portion 106.

The arm portion 110 is connected to the body portion 108 such that the arm portion 110 may be articulated in any desirable upward or downward position relative the body portion 108. Similar to the rotatable connection of the base portion 106 and body portion 108, the claw portion 112 may be rotatably-connected to the arm portion 110 such that the claw portion 112 may be pivoted 360° relative the arm portion 110. Movements of the portions 108-112 may be controlled manually with a joystick (not shown), or, alternatively, automatically by way of logic stored on a controller having a processor (not shown).

In the following description, it will be appreciated that prescribed movements of the body portion 108 relative the base portion 106 may have occurred before, during or after a described movement of the arm portion 110 and/or claw portion 112. For example, the body portion 108 may have been rotated, articulated or the like in order to locate the arm and claw portions 110, 112 in a desired position at or proximate a particular sub-station, such as, for example, the sub-station 104.

Still referring to FIG. 1, a plurality of wheels, W, may be disposed at the wheel repository sub-station 104. According to an embodiment, the wheel repository sub-station 104 is illustrated to include, for example, a rack 114; however, it will be appreciated that the wheel repository sub-station 104 may include an endless conveyor or the like.

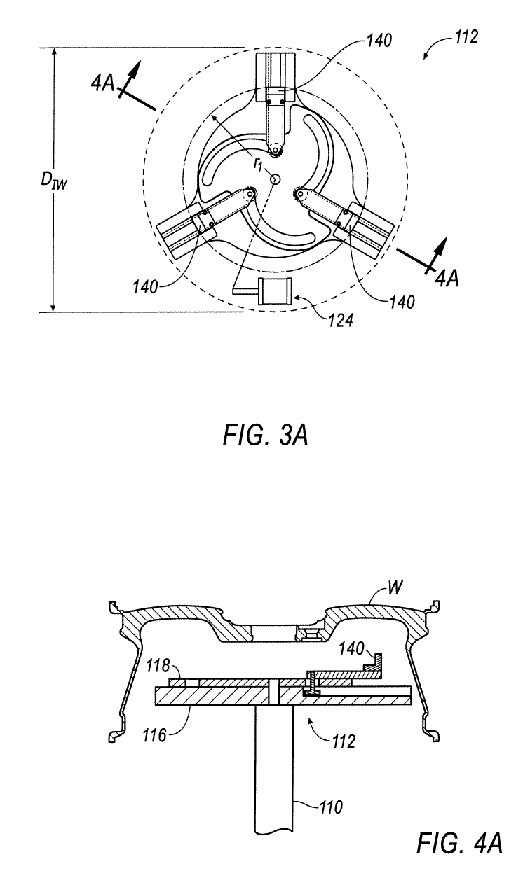

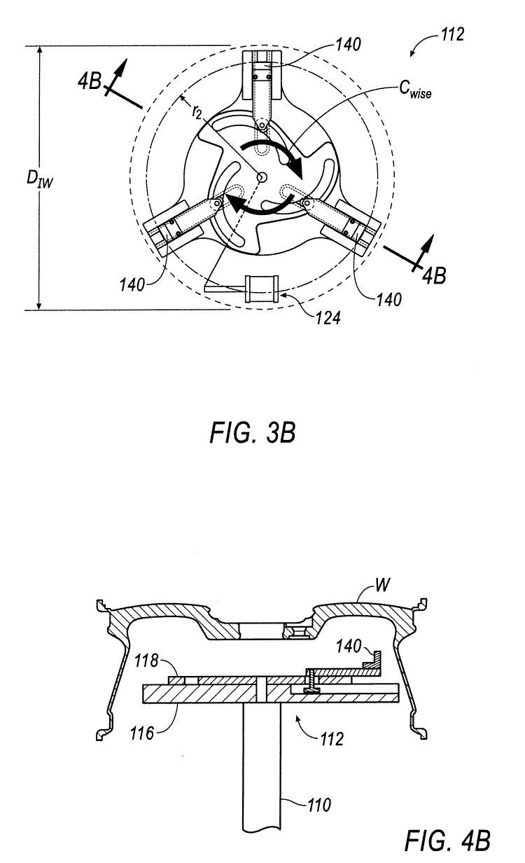

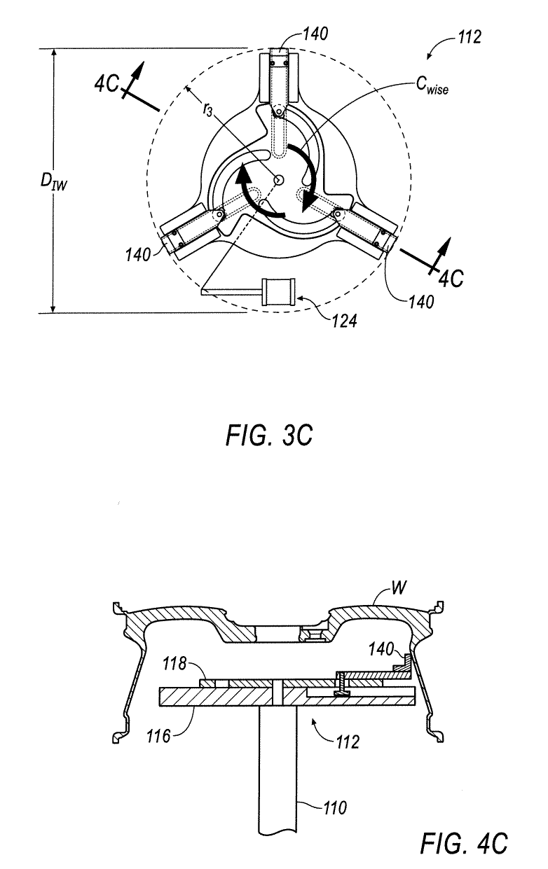

The claw portion 112 is shown retaining a wheel, W. In an embodiment, the claw portion 112 is interfaced with the wheel, W, by engaging an inner diameter, D_{IW} (see, e.g., FIGS. 3C and 4C), of the wheel, W. However, it will be appreciated that the interfacing of the claw portion 112 and wheel, W, may be conducted in any desirable manner and is not limited to the engagement of an inner diameter, D_{IW}, of the wheel, W.

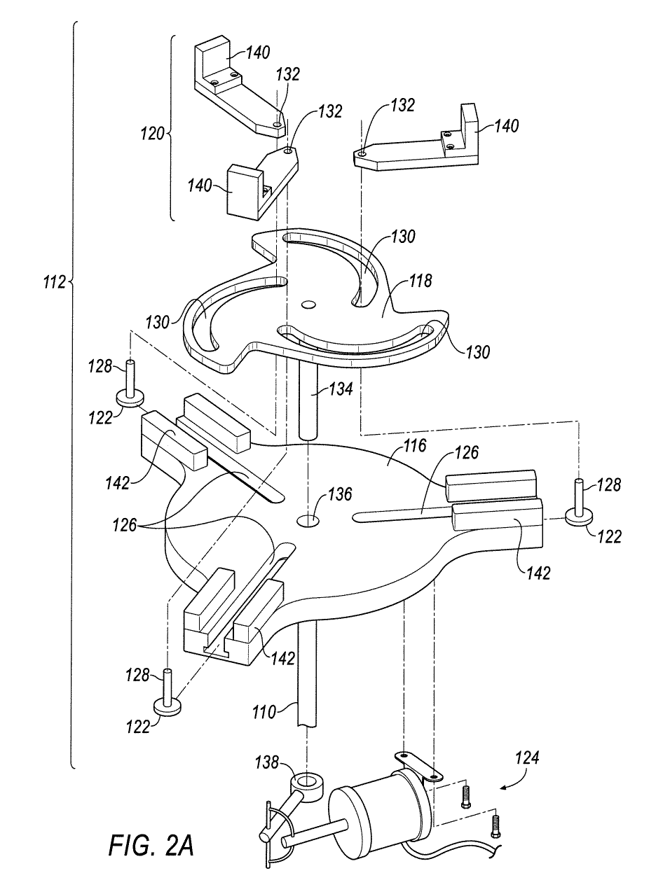

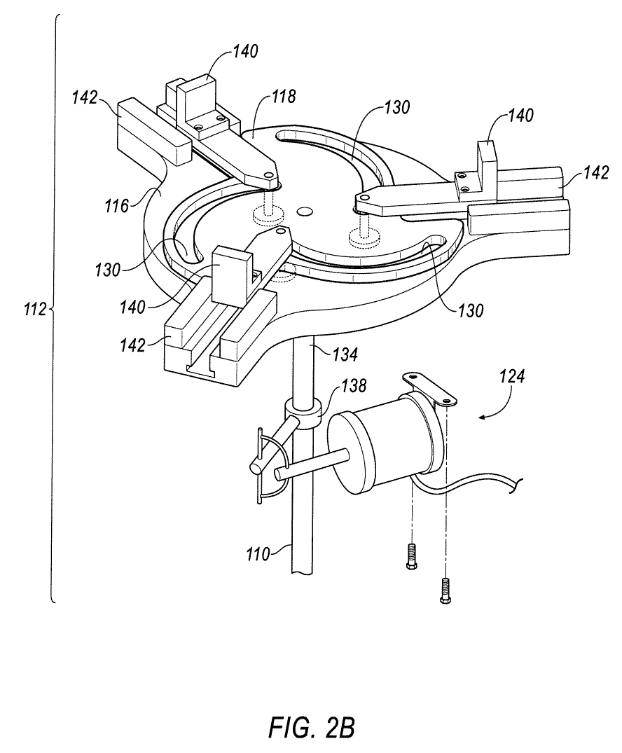

Referring now to FIGS. 2A and 2B, the claw portion 112 is shown and described according to an embodiment. In an embodiment, as seen in FIG. 2A, the claw portion 112 includes a fixed portion 116, a rotatable portion 118, wheel engaging portions 120, sliding portions 122 and an actuator portion 124.

The slidable portions 122 are slidably-disposed in radial channels 126 formed in the fixed portion 116. An axial post 128 extending from each of the slidable portions 122 extends through the radial channels 126 and arcuate channels 130 that are formed in the rotatable portion 118. The axial posts 128 also extend through an opening 132 formed in each of the wheel engaging portions 120.

A central axial post 134 extends from the rotatable portion 118 and through a central axial opening 136 formed in the fixed portion 116. Upon passing through the central axial opening 136, the central axial post 134 is fixed to a key passage 138 formed by and extending from the actuator portion 124. Once assembled, axial portions 140 of the engaging portions 120 are slidably-disposed in radial guides 142 of the fixed portion 116 such that the engagement portions 120 are moveable in an inward/outward radial direction.

Referring to FIGS. 3A-4C, an embodiment of operating the claw portion 112 is disclosed. In general, inward and outward radial movement of the axial portions 140 is dependent upon the state of the actuator 124.

As see in FIGS. 3A and 4A, the actuator 124 is in a deactuated state such that the axial portions 140 are in a radially-retracted position. The radially-retracted position is shown to be defined by a radial distance, r₁, of the axial portions 140 from a central axis extending through the central axial post 134.

When the actuator 124 is actuated, as shown in FIGS. 3B, 3C and 4B, 4C, the result is rotatable, clockwise movement, C_{WISE}, of the central axial post 134 due to the fact that the central axial post 134 is fixed or keyed to the key passage 138. The rotatable, clockwise movement, C_{WISE}, of the central axial post 134 translates into clockwise movement, C_{WISE}, of the rotatable portion 118, which translates into clockwise movement, C_{WISE}, of the axial posts 128 disposed in the arcuate channels 130, which translates into radial-outward movement of the slidable portions 122 disposed in the radial channels 126 and radial outward movement of axial portions 140 disposed in the radial guides 142.

As seen in FIGS. 3B, 3C and 4B, 4C, radially-outward positioning of the axial portions 140 is shown to be defined by progressively-increased radial distances, r₂, r₃, that are greater than the radial distance, r₁. When the axial portions 140 are advanced to the maximum radial distance, r₃, the axial portions 140 radially engage an inner diameter, D_{IW}, of the wheel, W, to secure the wheel, W, to the claw portion 112. Once the wheel, W, has been secured to the claw portion 112, the body portion 108 and arm portion 110 are oriented such that the claw portion 112 locates the wheel, W, proximate other substations included in the single-cell workstation 100, such as, for example, a lubricating sub-station, a tire mounting sub-station, an inflating station, and the like.

Referring to FIG. 5, a system for assembling a tire-wheel assembly, is shown generally at 200 according to an embodiment. The system 200 includes a robotic arm 202 having a base portion 206, a body portion 208, an arm portion 210 and a claw portion 212. The system 200 also includes a wheel repository station 204 including a rack 214.

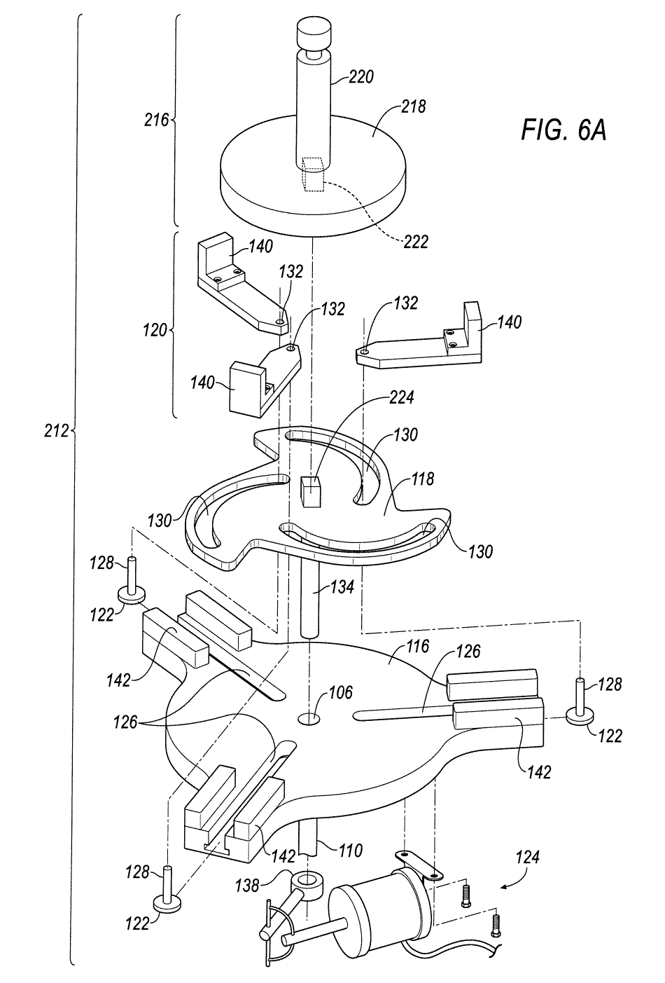

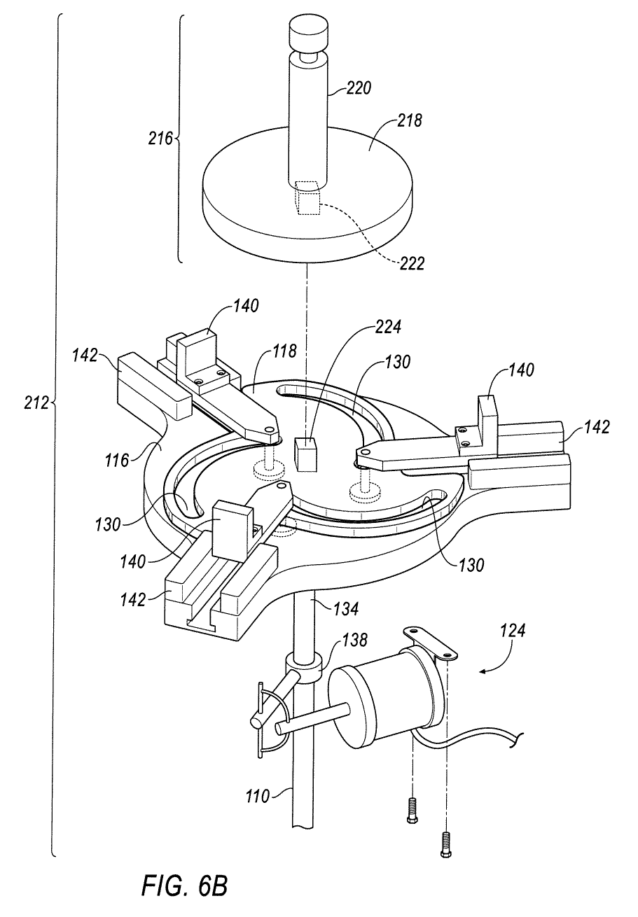

The claw portion 212 is substantially similar to the claw portion 112. The claw portion 212 however, includes a detachable portion that is shown generally at 216 in FIGS. 6A and 6B. The detachable portion 216 generally includes a plate 218 and a center-pull arm 220 that extends substantially perpendicularly from the plate 218. The plate 218 includes a recess 222 for receiving a coupling portion 224 extending from the rotatable portion 118.

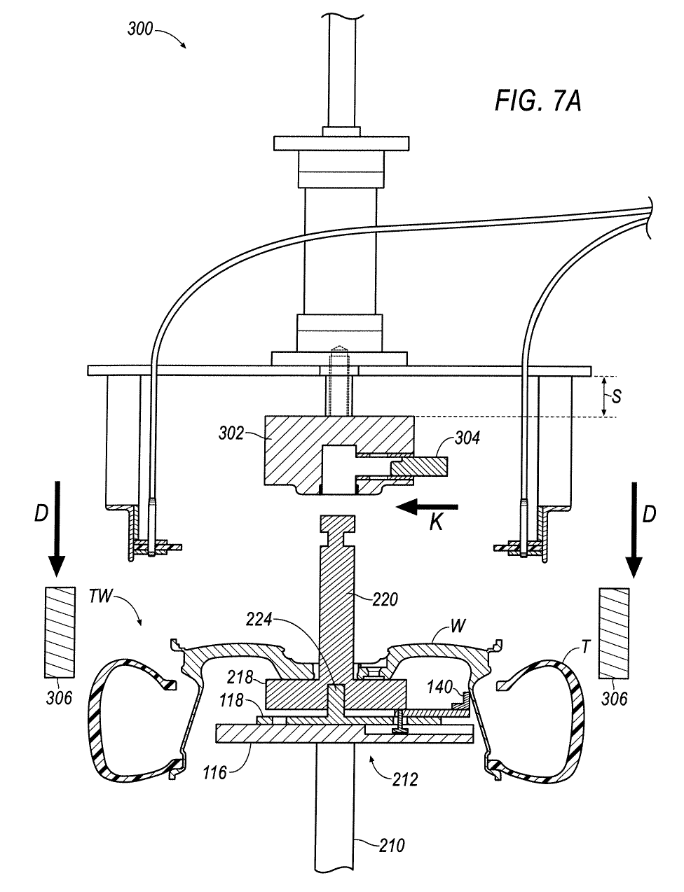

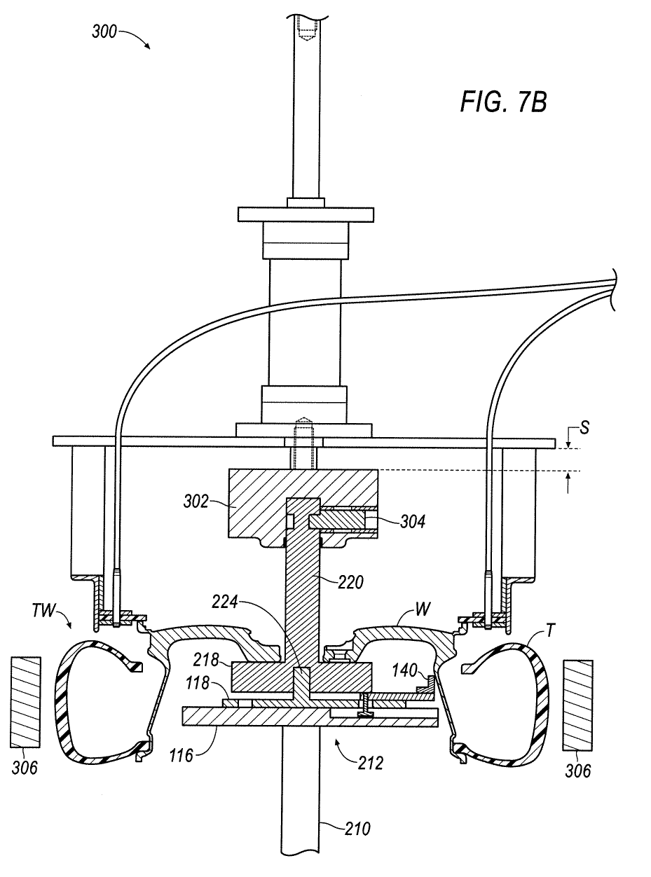

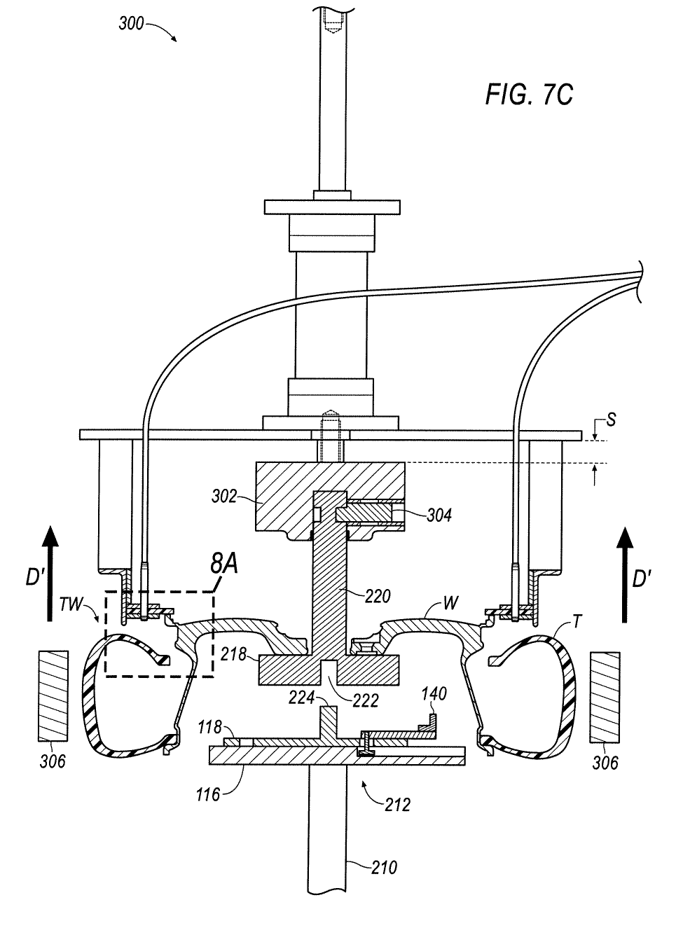

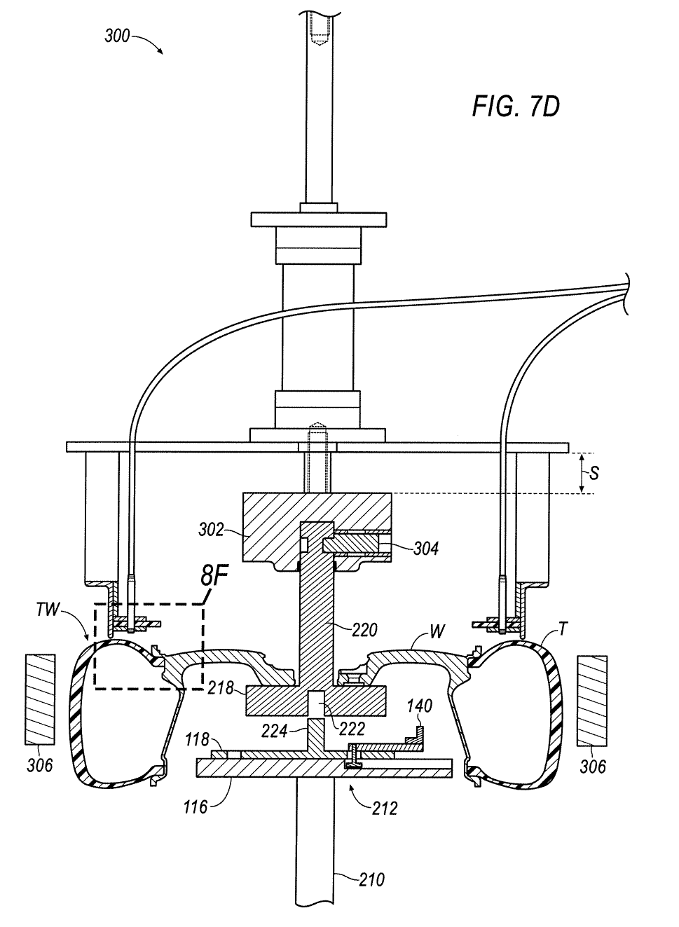

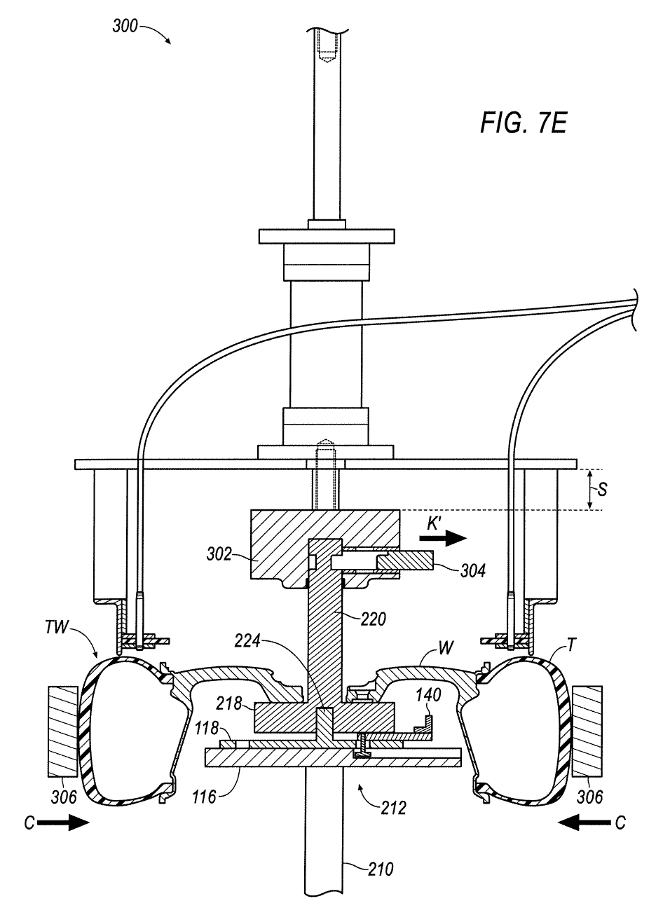

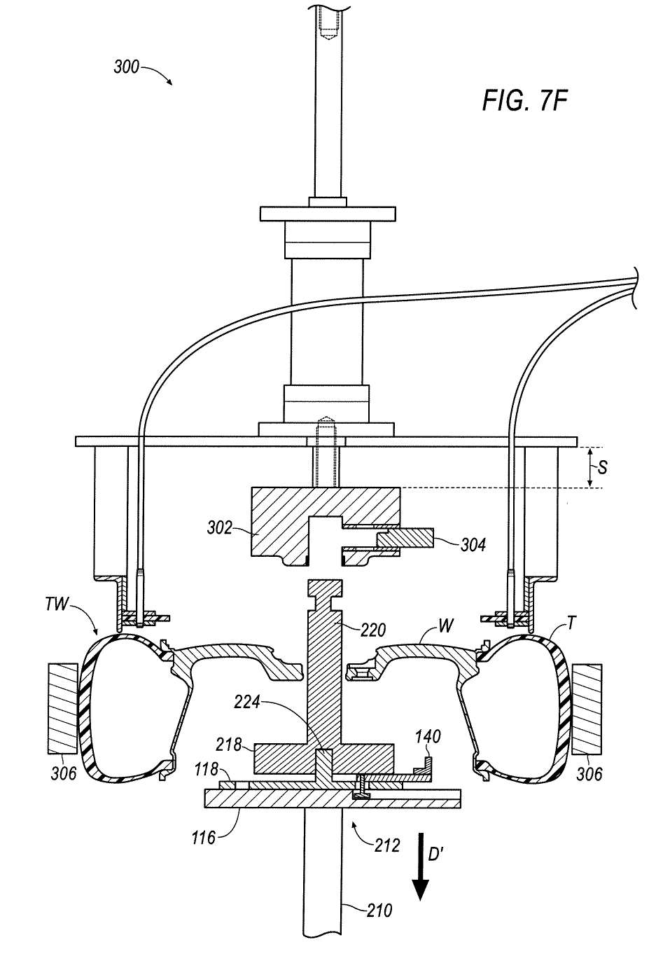

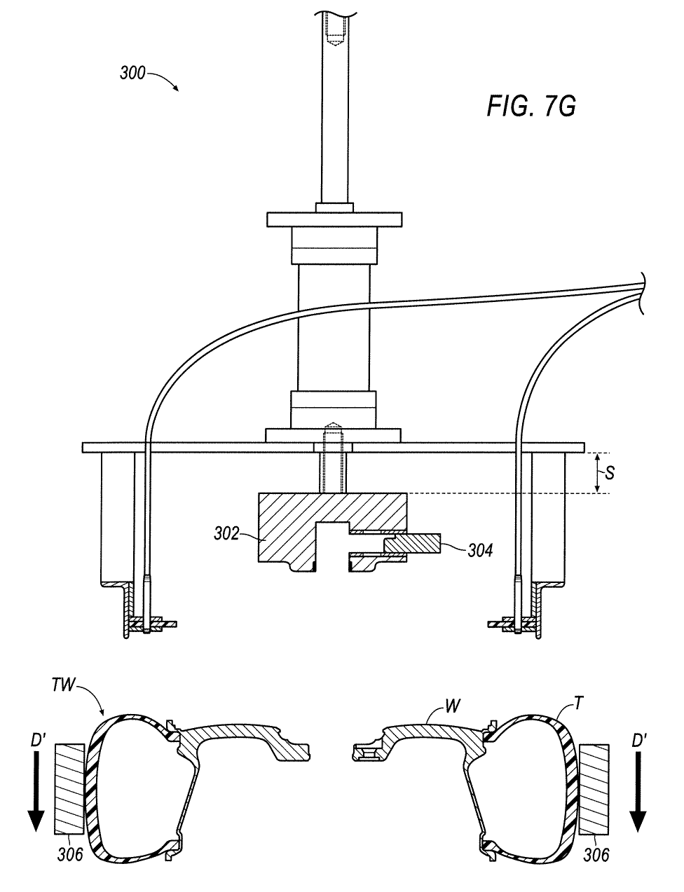

As illustrated, the coupling portion 224 is centrally located on the rotatable portion 118 such that the axis extending through the central axis post 134 also extends through the coupling portion 224. Although shown in a generic illustration, the coupling portion 224 and plate 218 may be joined mechanically, pneumatically, or the like at the recess 222. The function and purpose for detaching the detachable portion 216 from the rotatable portion 118 is explained in greater detail at FIGS. 7A-7G.

Referring now to FIG. 7A, the body portion 208 and arm portion 210 are orientated such that the claw portion 212 locates a non-inflated tire-wheel assembly, TW, proximate an inflating sub-station 300. As seen in FIG. 7A, once the arm portion 210 has located the non-inflated tire-wheel assembly, TW, proximate the inflating sub-station 300, the inflating sub-station 300 moves toward the tire-wheel assembly, TW, generally in the direction of the arrow, D.

Referring to FIGS. 7A and 7B, movement of the inflating sub-station 300 in the direction of the arrow, D, eventually results in the center-pull arm 220 of the detachable portion 216 being axially inserted into a locking device 302 of the inflating sub-station 300. Subsequently, one or more keys 304 of the locking device 302 is/are moved radially inwardly according to the direction of arrow, K, for radial engagement with the center-pull arm 220.

Referring to FIG. 7C, once the one or more keys 304 has radially engaged the center-pull arm 220, the axial portions 140 of the claw portion 212 radially disengage the inner diameter, D_{IW}, of the wheel, W, to release the wheel, W, from the arm portion 210 and claw portion 212. Then, subsequent to or coincident with the release of the wheel, W, from the claw portion 212, the coupling portion 224 and plate 218 are separated to thereby cause the plate 218 of the detachable portion 216 to retain the non-inflated tire-wheel assembly, TW, to the inflating sub-station 300 during an inflating operation.

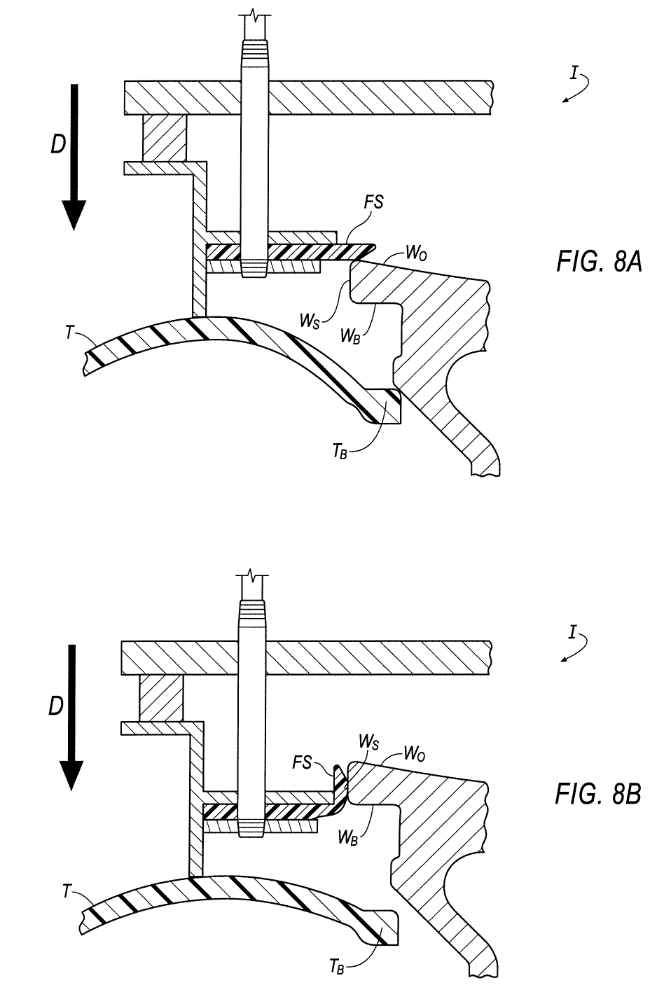

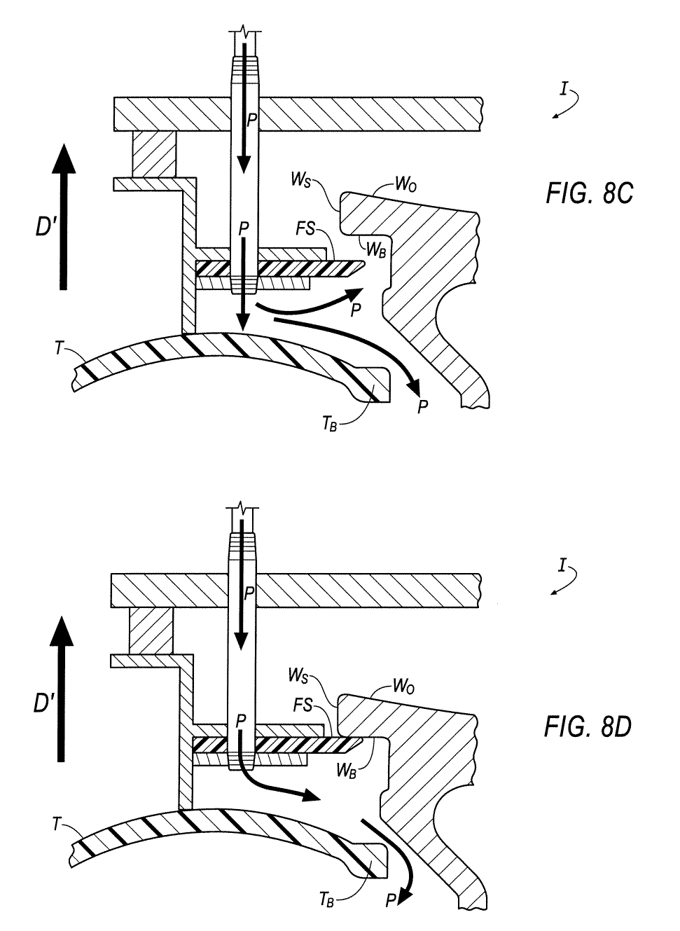

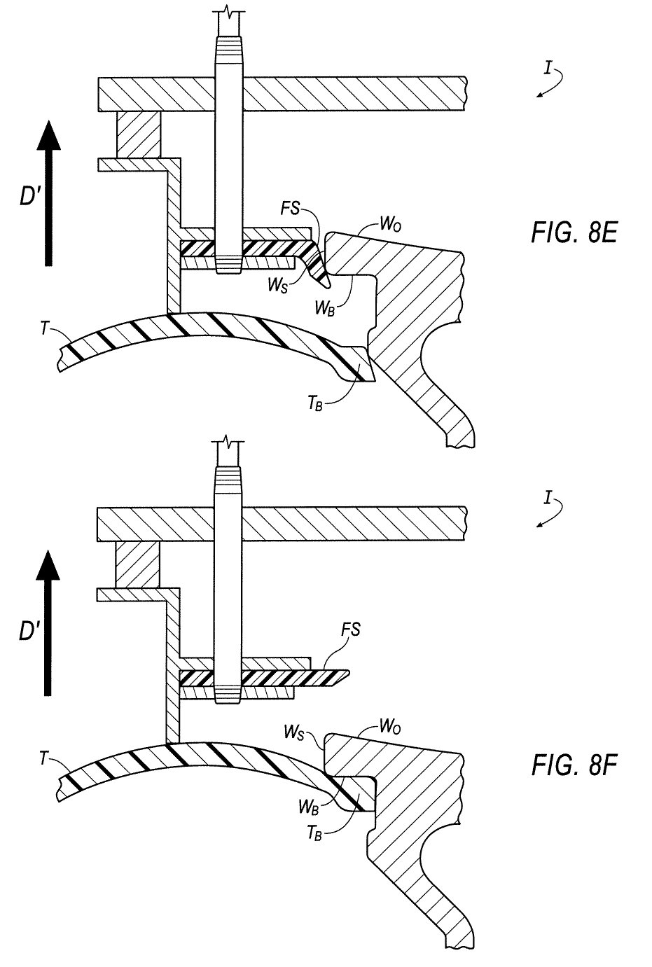

Referring now to FIG. 8A, an inflator assembly associated with the inflation sub-station 300 is shown generally at I according to an embodiment. The inflator assembly, I, generally includes a flip seal, FS, that interfaces with an outer surface, W_{O}, a side surface, W_{S}, and a bead seat, W_{B}, of the wheel, W. First, as seen in FIG. 8A, the flip seal, FS, is located adjacent the outer surface, W_{O}, of the wheel, W, as movement of the inflation assembly is directed in the direction of arrow, D. Then, as seen in FIG. 8B, as movement of the inflator assembly, I, persists in the direction of arrow, D, the flip seal, FS, is located substantially adjacent the side surface, W_{S}, of the wheel, W.

Then, as seen in FIG. 8C, the flip seal, FS, is moved past the side surface, W_{S}, of the wheel, W, such that pressurized fluid, P, may be provided by the inflator assembly, I. The pressurized fluid, P, causes the inflator assembly, I, to not only inflate the tire-wheel assembly, TW, but also, to move the inflator assembly, I, in a direction, D′, opposite the direction of the arrow, D. Accordingly, as seen in FIG. 8D, the flip seal, FS, is caused to be located adjacent a bead seat, W_{B}, of the wheel, W.

Then, as seen in FIG. 8E, the inflator assembly, I, may be retracted in the direction of the arrow, D′. The retraction of the inflator assembly, I, may be conducted by a motor (not shown), or, alternatively, by utilizing the pressurized fluid, P, to cause the inflator assembly, I, to “lift off” from the tire-wheel assembly, TW. Accordingly, the flip seal, FS, is shown to be disposed adjacent the side surface, W_{S}, of the wheel, W, as the pressurized fluid causes a bead, T_{B}, of the tire, T, to be moved toward the bead seat, W_{B}, of the wheel, W. Then, as seen in FIG. 8F, the pressurized fluid, P, causes the bead, T_{B}, of the tire, T, to be seated in the bead seat, W_{B}, of the wheel, W, as the inflator assembly, I, is further moved away from the tire-wheel assembly, TW, in the direction of the arrow, D′.

Referring to FIG. 7D, with the center pull arm 220 secured to the locking device 302, the tire, T, is shown to be inflated in accordance with the description associated with FIGS. 8A-8F. As seen in FIG. 7E, the detachable portion 216 and the rotatable portion 118 are then reconnected. Clamping portions 306 of the inflating sub-station 300 radially engage the tread surface of the tire, T, according to the direction of the arrow, C. Subsequent to or concurrent with the clamping, C, of the tread surface of the tire, T, the one or more keys 304 is/are moved radially outwardly in the direction of arrow, K′, and is/are radially disengaged with the center-pull arm 220.

Then, as seen in FIG. 7F, once the one or more keys 304 is radially disengaged from the center-pull arm 220, the arm portion 210 and claw portion 212 are cycled away from the inflating sub-station 300 in the direction of arrow, D′, such that the arm portion 210 and claw portion 212 are cycled to an idle position ready for receiving a wheel, W, in a subsequent assembling operation proximate the wheel repository station 104. Referring to FIG. 7G, once the arm portion 210 and claw portion 212 are cycled away from the inflating sub-station 300, according to the direction of the arrow, D′, the clamping portions 306 shuttle the inflated tire-wheel assembly, TW, downward in the direction of the arrow, D′, to another sub-station of the single-cell workstation 200.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A device for retaining a wheel having an inner diameter during an assembly operation of a tire-wheel assembly at a single-cell workstation, comprising:
a claw portion that releasably-attaches to the inner diameter of the wheel, including a fixed portion and a rotatable portion, wherein the rotatable portion is rotatably-disposed upon the fixed portion;
wheel-engaging portions slidably-disposed upon the rotatable portion;
sliding portions that are slidably-disposed within the fixed portion, wherein each sliding portion is coupled with one of each wheel-engaging portion, and
an actuator portion coupled to the rotatable portion.

2. The device according to claim 1, further comprising:
a robotic arm including
an arm portion, wherein the claw portion is connected to the arm portion.

3. The device according to claim 1, wherein the fixed portion includes a central axial opening, wherein the rotatable portion includes a central axial post, wherein the actuator portion including a key passage, wherein the central axial post extends through the central axial opening and the key passage.

4. The device according to claim 1, wherein the fixed portion includes radial guides and radial channels, wherein the rotatable portion includes arcuate channels.

5. The device according to claim 4, wherein the wheel-engaging portions each includes an axial portion and an opening, wherein each axial portion is slidably-disposed in one of each of the radial guides, wherein the sliding portions are slidably-disposed in the radial channels, wherein the sliding portions each includes an axial post that extend through the radial channels, the arcuate channels and the opening of each wheel-engaging portion

6. A device for retaining a wheel having an inner diameter during an assembly operation of a tire-wheel assembly at a single-cell workstation, comprising:
a claw portion that releasably-attaches to the inner diameter of the wheel, including a fixed portion and a rotatable portion, wherein the rotatable portion is rotatably-disposed upon the fixed portion;
wheel-engaging portions slidably-disposed upon the rotatable portion;
sliding portions that are slidably-disposed within the fixed portion, wherein each sliding portion is coupled with one of each wheel-engaging portion;
an actuator portion coupled to the rotatable portion, wherein the rotatable portion further comprises a coupling portion; and
a detachable portion that is releasably-attached to the coupling portion.

7. The device according to claim 6, wherein the detachable portion includes a plate, a center pull arm extending from the plate, and a recess formed in the plate that receivably-corresponds to the coupling portion.

8. The device according to claim 6, further comprising:
a robotic arm including
an arm portion, wherein the claw portion is connected to the arm portion.

9. The device according to claim 6, wherein the fixed portion includes a central axial opening, wherein the rotatable portion includes a central axial post, wherein the actuator portion including a key passage, wherein the central axial post extends through the central axial opening and the key passage.

10. The device according to claim 6, wherein the fixed portion includes radial guides and radial channels, wherein the rotatable portion includes arcuate channels.

11. The device according to claim 10, wherein the wheel-engaging portions each includes an axial portion and an opening, wherein each axial portion is slidably-disposed in one of each of the radial guides, wherein the sliding portions are slidably-disposed in the radial channels, wherein the sliding portions each includes an axial post that extend through the radial channels, the arcuate channels and the opening of each wheel-engaging portion

12. A method for operating a device for retaining a wheel during an assembly operation, comprising the steps of:
positioning a claw portion proximate the wheel;
actuating an actuator; and
responsive to the actuation of the actuator, engaging the wheel with the wheel-engaging portions of the claw portion.

14. The method according to claim 13, further comprising the steps of:
engaging a detachable portion of the claw portion with a sub-station of the single-cell workstation;
disengaging the wheel-engaging portions from the wheel;
releasing the detachable portion from the claw portion; and
supporting the wheel at the sub-station with the detachable portion.

15. The method according to claim 14, further comprising the steps of:
re-engaging the claw portion with the detachable portion;
securing one or more of the wheel and a tire mounted to the wheel at the sub-station; and
shuttling the claw portion and detachable portion away from the sub-station while one or more of the wheel and tire mounted to the wheel is secured at the sub-station.
